(19) United States
(12) Patent Application Publication
(10) Pub. No.: US 2008/0159395 A1
(43) Pub. Date: Jul. 3, 2008

(54) VIDEO SIGNAL PROCESSING CIRCUIT, VIDEO SIGNAL PROCESSING APPARATUS, AND VIDEO SIGNAL PROCESSING METHOD

(75) Inventor: Munehiro TERADA, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/856,815

(22) Filed: Sep. 18, 2007

(30) Foreign Application Priority Data
Dec. 27, 2006 (JP) 2006-352246

(51) Int. Cl. H04N 7/26

(52) U.S. Cl. 375/240.16; 375/E07.124

(57) ABSTRACT

According to one embodiment, there is provided a video signal processing circuit including: an image processing circuit configured to process a video signal which is displayed on an image display section; and a motion picture enhancement circuit configured to acquire, from the image processing circuit, the video signal and a pixel information representing presence/absence of a graphic in the video signal on a per-pixel basis and process a double speed conversion for a pixel not having a graphic in the video signal by a frame interpolation through a motion compensation prediction of the pixel.

### CROSS-REFERENCE TO RELATED APPLICATIONS

This application is based upon and claims the benefit of priority from Japanese Patent Application No. 2006-352246, filed on Dec. 27, 2006; the entire contents of which are incorporated herein by reference.

### BACKGROUND

1. Field

One embodiment of the invention relates to a video signal processing circuit, a video signal processor, and a video signal processing method that enable subjecting of a video signal to double speed conversion processing complying with a motion compensation frame interpolation scheme.

2. Description of the Related Art

A set into which a motion picture enhancement technique, such as a double speed conversion processing technique complying with a motion compensation frame interpolation scheme, or the like, is introduced has become prevalent as a TV receiver typified by a liquid-crystal TV (television). It is disclosed by, for example JP-A-2002-209191, that the double speed conversion processing technique complying with the motion compensation frame interpolation scheme is a technique for generating a frame interpolation signal from a video signal and a motion vector and subjecting the video signal to double speed conversion processing by use of the frame interpolation signal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an internal configuration of a TV receiver according to an embodiment of the invention;

FIG. 2 is an exemplary block diagram showing the internal configuration of a motion picture enhancement circuit shown in FIG. 1;

FIG. 3 is an exemplary view showing a graphic-superimposed image and pixel information indicated by an arrowed line;

FIG. 4 is an exemplary view showing a graphic-superimposed image and pixel information indicated by an arrowed line; and

FIG. 5 is an exemplary view showing an image into which a graphic and a background are blended together, and pixel information indicated by an arrowed line.

### DETAILED DESCRIPTION

Various embodiments according to the invention will be described hereinafter with reference to the accompanying drawings. In general, according to one embodiment of the invention, there is provided a video signal processing circuit including: an image processing circuit configured to process a video signal which is displayed on an image display section; and a motion picture enhancement circuit configured to acquire, from the image processing circuit, the video signal and a pixel information representing presence/absence of a graphic in the video signal on a per-pixel basis and process a double speed conversion for a pixel not having a graphic in the video signal by a frame interpolation through a motion compensation prediction of the pixel.

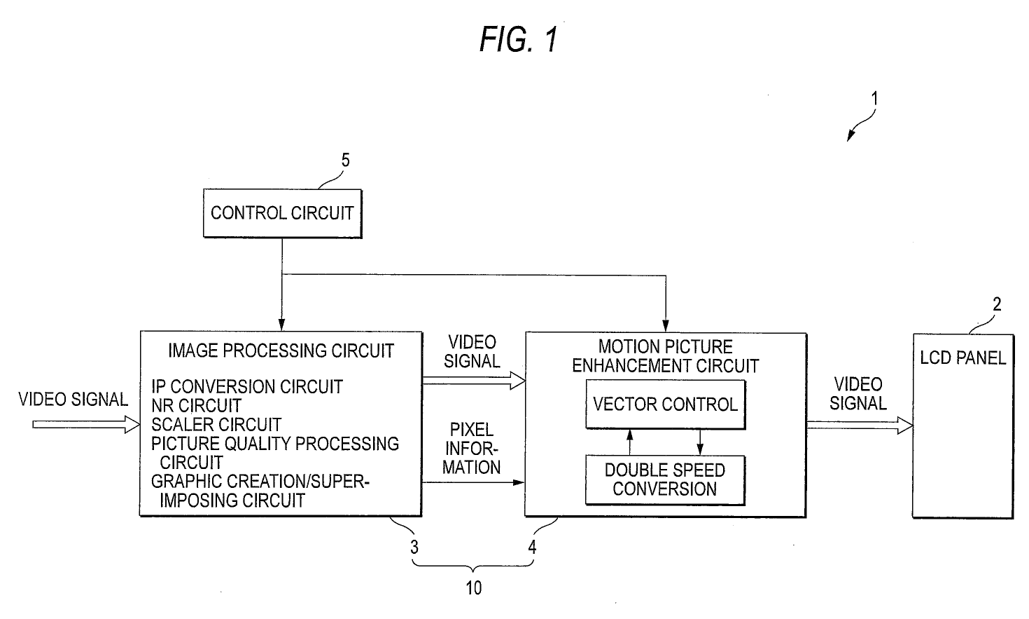

According to an embodiment, FIG. 1 shows a TV receiver (a video signal processor). The TV receiver (a video signal processor) 1 has an LCD (Liquid-Crystal Display) panel (an image display section) 2; an image processing circuit 3; a motion picture enhancement circuit 4; and a control circuit 5. An input video signal is converted into a format suitable for the LCD panel 2 by the image processing circuit 3 and the motion picture enhancement circuit 4, and the thus-converted signal is displayed on the LCD panel 2. The image processing circuit 3 and the motion picture enhancement circuit 4 serve as a video signal processing circuit 10.

The image processing circuit 3 subjects the video signal to image processing for displaying the video signal on the LCD panel 2, and outputs the video signal having undergone image processing. Specifically, the image processing circuit 3 has an IP conversion circuit for converting a video signal of an interlace scheme into a video signal of a progressive scheme; an NR circuit for diminishing noise arising in an image; a scaler circuit for resizing an image to a size at which the image can be displayed on the LCD panel 2; a picture quality processing circuit for adjusting picture quality; and a graphic creation/superimposing circuit for creating a graphic and superimposing the thus-created graphic on a motion picture.

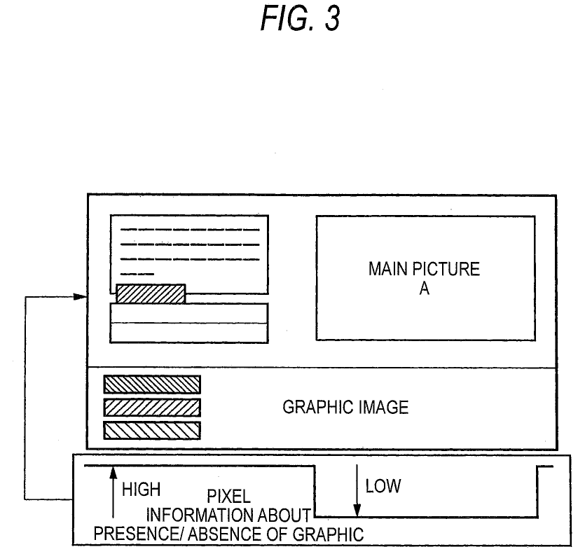

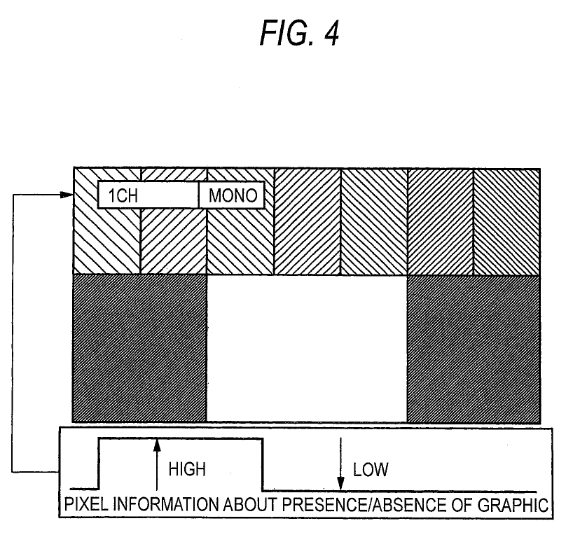

The image processing circuit 3 outputs pixel information showing presence/absence of a graphic in a video signal on a per-pixel basis. Pixel information corresponds to, e.g., 1-bit data set by the control circuit 5, and enables switching presence/absence of a graphic superimposed by the image processing circuit 3, such as an OSD, as a High/Low state on a per-pixel basis. As shown in FIGS. 3 and 4, the control circuit 5 sets the pixel information such that a pixel having a graphic in a video signal is brought into a High state and such that a pixel not having a graphic in the video signal is brought into a Low state.

The motion picture enhancement circuit 4 acquires a video signal and pixel information which have been output from the image processing circuit 3. In accordance with the pixel information, the motion picture enhancement circuit 4 performs frame interpolation processing through motion compensation prediction (i.e., performs vector control processing) in connection with only a pixel not having a graphic (a pixel in a Low state) in the video signal, thereby subjecting the video signal to double speed conversion processing. However, in accordance with pixel information, the motion picture enhancement circuit 4 does not perform frame interpolation processing (i.e., deactivates vector control processing) in connection with a pixel having a graphic (a pixel in a High state) in the video signal. Specifically, the motion picture enhancement circuit 4 subjects the pixel having a graphic (i.e., the pixel in a high state) in the video signal to simple double speed conversion processing.

The term “motion compensation prediction” used herein means frame inter-frame prediction. Specifically, an image of interest and a preceding image are divided into macro blocks (e.g., blocks consisting of 16 pixels and 16 lines). There is prepared a motion vector showing the moving direction and the amount of movement of corresponding blocks between the image of interest and the preceding image. The image of interest is predicted from the preceding image in accordance with the motion vector. Further, the term “frame interpolation processing” means processing to which a video signal is subjected in accordance with inter-frame prediction.

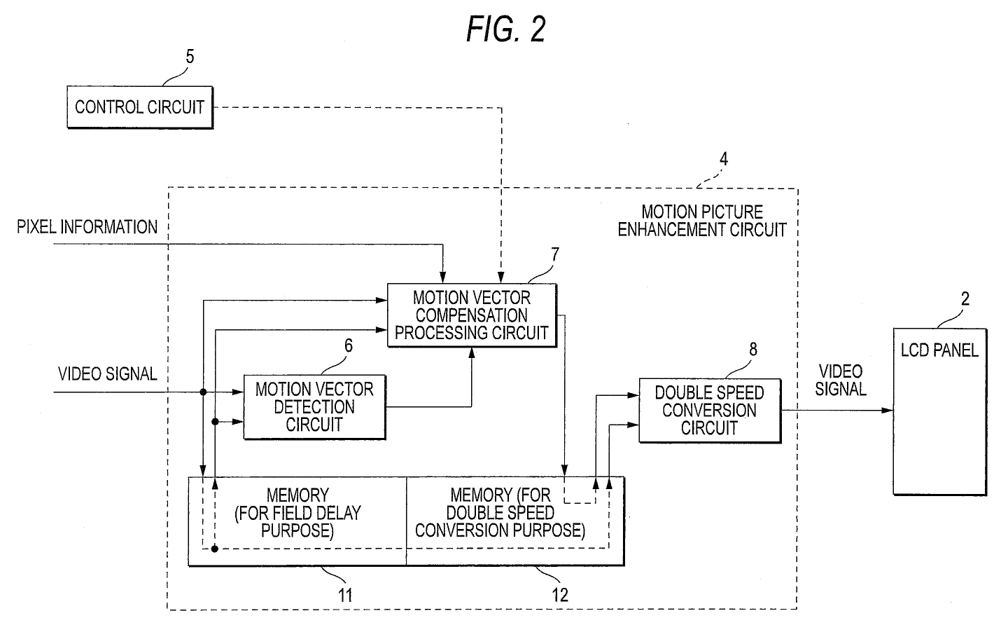

As shown in FIG. 2, the motion picture enhancement circuit 4 has a motion vector detection circuit 6 for detecting a motion vector from a video signal; a motion vector interpolation processing circuit 7 for performing frame interpolation processing in accordance with a video signal and a motion vector; a double speed conversion circuit 8 for subjecting the video signal to double speed conversion processing; memory 11 for a field delay purpose (hereinafter called “field delay memory”); and memory 12 for a double speed conversion purpose (hereinafter called “double speed conversion memory”).

The video signal output from the image processing circuit 3 is divided into a video signal of a current field and a video signal which has undergone a field delay by way of the memory 11. The thus-divided video signals are input to the motion vector detection circuit 6. In accordance with a result of determination of a field difference, the motion vector detection circuit 6 detects a motion vector and outputs a result of detection to the motion vector interpolation processing circuit 7.

A detection result of the motion vector output by the motion vector detection circuit 6 is input to the motion vector interpolation processing circuit 7. The pixel information output by the image processing circuit 3, the video signal of the current field and the video signal having undergone a field delay by way of the memory 11 are also input to the motion vector interpolation processing circuit 7. In accordance with pixel information, the motion vector interpolation processing circuit 7 performs frame interpolation processing through motion compensation prediction in connection with a pixel not having a graphic (a pixel in a low state) in the video signal. In accordance with pixel information, a pixel having a graphic (a pixel in a high state) in the video signal is not subjected to frame interpolation processing, and the processed video signal is output to the memory 12.

The video signal having passed through the memory 12 is input to the double speed conversion circuit 8. The video signal having passed through the pieces of memory 11, 12 is also input to the double speed conversion circuit 8. The double speed conversion circuit 8 subjects the video signal to double speed conversion processing by use of the video signals. When the vertical frequency of the input video signal is 50 Hz, the frequency is converted to 100 Hz through double speed conversion. In the case of a frequency of 60 Hz, the frequency is converted to 120 Hz. Thus, the video signal is displayed on the LCD panel 2.

As has been described above, the motion picture enhancement circuit 4 acquires the video signal output by the image processing circuit 3 and the pixel information A pixel not having a graphic in the video signal is subjected to frame interpolation processing through motion compensation prediction. In the meantime, a pixel having a graphic in the video signal is subjected to double speed conversion processing without performance of frame interpolation processing. As a result, when a graphic is superimposed on a motion picture, the video signal, including a graphic area, is handled as a motion picture signal, whereby the video signal is prevented from being subjected to double speed conversion processing complying with a motion compensation frame interpolation scheme. Accordingly, there is prevented occurrence of, e.g., a situation where an image in a graphic area collapses; for example, in the form of disordering of an edge of the graphic area. Therefore, the TV receiver 1 can readily realize a setting of superior image quality by use of the pixel information output by the image processing circuit 3.

The present invention is not limited to the above-described embodiment.

For instance, the double speed conversion circuit 8 can also cope with switching of vector control in accordance with pixel information. A direct system video signal input to the double speed conversion circuit 8 and an interpolation-system video signal having passed through the motion vector interpolation processing circuit 7 may also be switched in the double speed conversion circuit 8 on every field, thereby switching between paths in accordance with the pixel information.

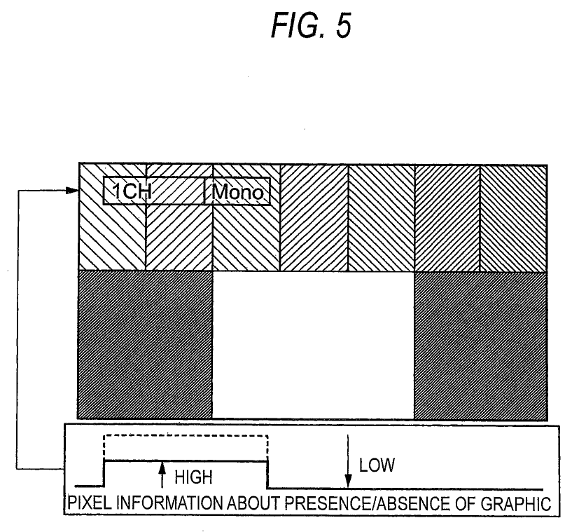

In relation to a pixel to which a graphic is blended (e.g., □-blended or the like) in a video signal, the motion picture enhancement circuit 4 may perform frame interpolation processing through motion compensation prediction in accordance with the amount of movement of a motion vector increased or decreased according to a blending rate, thereby subjecting the video signal to double speed conversion processing. Specifically, as shown in FIG. 5, when the graphic superimposed by the image processing circuit 3 is blended with a background, the amount of movement of a motion vector (the amount of vector) is varied in accordance with a proportion of blending. In accordance with the information output by the control circuit 5, the motion vector interpolation processing circuit 7 clips (limits) the maximum amount of vector available in a vertical/horizontal direction.

### EXAMPLE 1

When a blending proportion is 70% (when a background is transparent by 70%) Vertical/horizontal vector clip value=MAX value×0.7

### EXAMPLE 2

When the blending proportion is 0% (when a background is totally opaque) Vertical/horizontal vector clip value=MAX value×0

According to the above-described embodiment, image quality is superior. While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing circuit comprising:
an image processing circuit configured to process a video signal which is displayed on an image display section; and
a motion picture enhancement circuit configured to acquire, from the image processing circuit, the video signal and a pixel information representing presence/absence of a graphic in the video signal on a per-pixel basis and process a double speed conversion for a pixel not having a graphic in the video signal by a frame interpolation through a motion compensation prediction of the pixel.

2. The video signal processing circuit according to claim 1, wherein the motion picture enhancement circuit comprises:
a motion vector detection circuit configured to detect a motion vector in accordance with the video signal;
a motion vector interpolation processing circuit configured to perform the frame interpolation in accordance with the video signal and the motion vector; and
a double speed conversion circuit configured to process the double speed conversion for the video signal.

3. The video signal processing circuit according to claim 2, wherein the pixel information is acquired by the motion vector interpolation processing circuit, and
wherein the motion vector interpolation processing circuit processes a frame interpolation in connection with the pixel not having the graphic in the video signal in accordance with the video signal and the motion vector, and outputs the video signal, and
wherein the double speed conversion circuit processes a double speed conversion of the video signal by the output video signal.

4. The video signal processing circuit according to claim 1, wherein the motion picture enhance circuit processes the double-speed conversion by the frame interpolation through the motion compensation prediction in connection with a pixel in the video signal with which a graphic is blended, in accordance with an amount of movement of a motion vector increased/decreased according to a blending rate.

5. A video signal processing apparatus comprising:
an image display section;
an image processing circuit configured to process a video signal which is displayed on the image display section; and
a motion picture enhancement circuit configured to acquire, from the image processing circuit, the video signal and a pixel information representing presence/absence of a graphic in the video signal on a per-pixel basis and process a double speed conversion for a pixel not having a graphic in the video signal by a frame interpolation through a motion compensation prediction of the pixel.

6. A video signal processing method comprising:
processing a video signal which is displayed on an image display section;
acquiring, from the image processing circuit, the video signal and a pixel information representing presence/absence of a graphic in the video signal on a per-pixel basis; and
processing a double speed conversion for a pixel not having a graphic in the video signal by a frame interpolation through a motion compensation prediction of the pixel.

7. The video signal processing method according to claim 6, comprising:
detecting a motion vector in accordance with the video signal;
performing the frame interpolation in accordance with the video signal and the motion vector; and
processing the double speed conversion for the video signal.

8. The video signal processing method according to claim 7, comprising:
acquiring the pixel information;
processing a frame interpolation in connection with the pixel not having the graphic in the video signal in accordance with the video signal and the motion vector;
outputting the video signal; and
processing a double speed conversion of the video signal by the output video signal.

9. The video signal processing circuit according to claim 6, comprising:
processing the double-speed conversion by the frame interpolation through the motion compensation prediction in connection with a pixel in the video signal with which a graphic is blended, in accordance with an amount of movement of a motion vector increased/decreased according to a blending rate.
